(19) United States
(12) Patent Application Publication
(10) Pub. No.: US 2012/0154853 A1
(43) Pub. Date: Jun. 21, 2012

(54) IMAGE PROCESSING APPARATUS, METHOD, AND PROGRAM

(75) Inventor: RITSUKO OTAKE, Kawasaki-shi (JP)

(73) Assignee: CANON KABUSHIKI KAISHA, Tokyo (JP)

(21) Appl. No.: 13/286,651

(22) Filed: Nov. 1, 2011

(30) Foreign Application Priority Data
Dec. 17, 2010 (JP) 2010-281440

(51) Int. Cl. G06F 15/00

(52) U.S. Cl. 358/1.15

(57) ABSTRACT

An image processing apparatus comprises: a conversion unit that converts an original into image data by scanning the original; a detection unit that detects a blank page in the image data converted by the conversion unit; a separation unit that deletes image data of the blank page detected by the separation unit from the converted image data; and a transmission unit that transmits to an external apparatus (a) the converted image data from which the image data of the blank page is separated by the separation unit, (b) the separated image data of the blank page, and (c) notification information formed based on a separation result by the separation unit.

### BACKGROUND OF THE INVENTION

1. Field of the Invention

The present invention relates to a method of handling image data at the time when an original has been read and a blank page has been detected in an image processing apparatus and to a program for executing such a method.

2. Description of the Related Art

In an apparatus for transmitting image data formed by reading an original of a plurality of pages, such a technique that what is called a blank page having no contents is automatically detected and deleted from transmission data has widely been known. However, there are a variety of methods of compensating a detecting precision of the blank page. For example, there is such a technique that pages which were determined as blank pages are displayed together with other page information before transmission and the user designates whether or not those pages are deleted from read image data one page by one (refer to Japanese Patent Application Laid-Open No. 2007-208618). There is also such a technique that after data in which blank pages had automatically been deleted was transmitted, its detection result is output to the transmission side (refer to Japanese Patent Application Laid-Open No. 2000-92261).

### SUMMARY OF THE INVENTION

Although the method whereby whether or not the page which was determined as a blank page is deleted from the transmission data is confirmed by the user before the transmission is effective to avoid a deletion error of the blank page, the user who actually operates an apparatus cannot always judge a significance degree of each page of the original. Even if the user can judge it, there is such a problem that in order to execute the accurate deletion of the blank page, the number of operating steps increases remarkably. Further, there is such a problem that the data receiving side does not have a unit for confirming information regarding the deleted page.

To solve the problems discussed above, the present invention provides an image processing apparatus comprising: a conversion unit configured to convert an original into image data by scanning the original; a detection unit configured to detect a blank page in the image data converted by the conversion unit; a separation unit configured to separate image data of the blank page detected by the detection unit from the converted image data; and a transmission unit configured to transmit to an external apparatus (a) the converted image data from which the image data of the blank page is separated by the separation unit, (b) the separated image data of the blank page, and (c) notification information formed based on a separation result by the separation unit.

According to the invention, the image processing apparatus has a unit configured to transmit (a) image data obtained by reading an original document having a plurality of pages, from which image data for a blank page or pages are separated, and (b) information regarding the separated image data. Therefore, the recipient can confirm, on the spot, that image data for a blank page or pages existing mixedly in the original has been separated from the received data and the information showing number(s) of separated blank page(s) in the original.

Further features and aspects of the present invention will become apparent from the following description of exemplary embodiments with reference to the attached drawings.

### BRIEF DESCRIPTION OF THE DRAWINGS

FIG. 1 is a diagram illustrating a construction of a control system which is installed in a digital multifunction apparatus.

FIG. 2 is a diagram illustrating a construction of a blank page processing unit.

FIG. 3 is a flowchart illustrating a flow for blank page processing.

FIG. 4 is a flowchart illustrating a transmitting process using a blank-skipping function.

FIG. 5 is a conceptual diagram of E-mail which is transmitted by using the blank-skipping function.

FIGS. 6A and 6B are conceptual diagrams of transmission files.

FIG. 7 is an example of a header of a facsimile.

FIG. 8 is an example of a blank page transmission of the facsimile.

FIG. 9 is an example of a blank-skipping function setting display screen.

FIG. 10 is an example of a preview mode setting display screen.

### DESCRIPTION OF THE EMBODIMENTS

Embodiments of the invention will be described hereinbelow with reference to the drawings.

### Embodiment 1

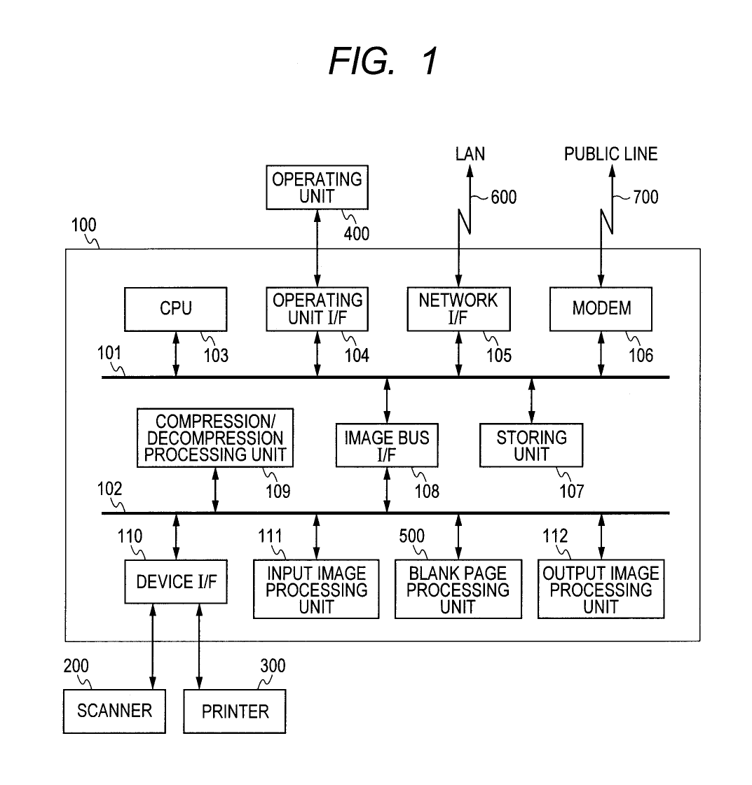

FIG. 1 illustrates a construction of a control system which is installed in a digital multifunction apparatus to which the embodiment is applied. A controller unit 100 is connected to a scanner 200 serving as an image input apparatus and a printer 300 serving as an image output apparatus and is connected to a LAN 600 and a telephone line 700, thereby inputting and outputting image data and device information and controlling the whole system. A CPU 103 functions as a controller for controlling the whole digital multifunction apparatus. An operating unit I/F 104 is an interface unit with an operating unit 400 and outputs the image data to be displayed to a display unit (not shown) on the operating unit 400 to the operating unit 400. The operating unit I/F 104 also plays a role for transferring information which was input by the user from the operating unit 400 to the CPU 103. A network I/F 105 is connected to the LAN 600 and inputs and outputs information. A modem 106 is connected to the public line 700 and executes a modulating/demodulating process for transmitting and receiving data. A storing unit 107 is used to store the image data or compressed data. A system work memory and the like by which the CPU 103 operates are also included in the storing unit 107. The above devices are arranged on a system bus 101.

An image bus I/F 108 is a bus bridge to which the system bus 101 and an image bus 102 for transferring the image data at a high speed are connected and which converts a data structure. The image bus 102 is constructed by a high speed bus such as PCI bus, IEEE1394, or the like. A compression/decompression processing unit 109 compresses and decompresses the image data by a predetermined compressing/decompressing method. The scanner 200 and printer 300 serving as image input/output apparatuses and the controller unit 100 are connected to a device I/F 110 and the device I/F 110 executes a conversion of a synchronous system/asynchronous system of the image data. An input image processing unit 111 executes a correction, a modification, and an edition to the image data obtained by the scanner 200 and executes a process suitable for a subsequent print output or image transmission. A blank page processing unit 500 executes a discrimination every page to see if the image data obtained by the scanner 200 is a blank page or not on the basis of a size of image data compressed by the compression/decompression processing unit 109 or the like and processes the data which was determined as a blank page.

An output image processing unit 112 executes a correction and a data conversion which are suitable mainly for the printer to the image data.

The scanner 200 illuminates the original and executes a scan or the like of a CCD line sensor, thereby converting the original into an electric signal showing an image on the original and forming digital image data. The printer 300 outputs the image data as an image on a sheet. As an image output method, there is an electrophotographic method using a photosensitive drum and a photosensitive belt, an ink jet method whereby ink is discharged from a micronozzle array and an image is directly printed onto the sheet, and the like. Any one of those methods may be used.

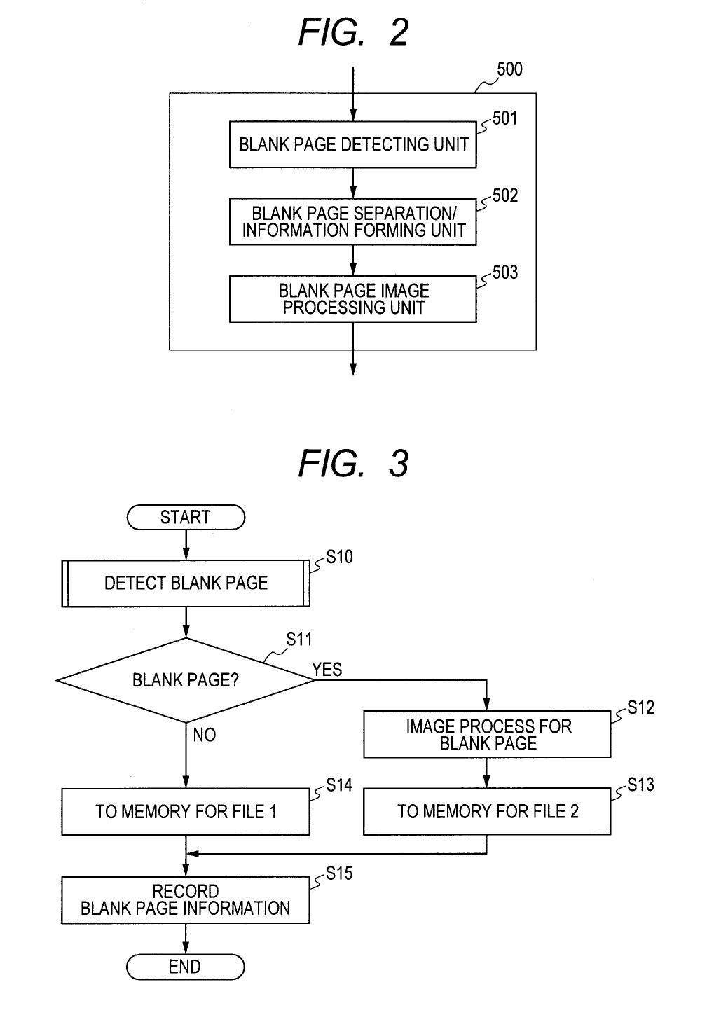

FIG. 2 illustrates an inner construction of the blank page processing unit 500. The image data obtained by the scanner 200 is input to the blank page processing unit 500 one page by one. A blank page detecting unit 501 discriminates whether or not the input page is a blank page. At this time, for example, the data size of the image data compressed by the compression/decompression processing unit 109 is compared with a predetermined threshold value. When it is equal to or less than the threshold value, it is determined that the input page is the blank page. The blank page detecting method is not limited to the above blank page detecting method but an arbitrary method can be also applied. A blank page separation/information forming unit 502 executes processes for forming information to distinguish the page which was determined as a blank page by the blank page detecting unit 501 from a normal page and holding the image data of the blank page separately from image data of the normal page. A blank page image processing unit 503 executes an image process only for the blank page to the page which was determined as a blank page by the blank page detecting unit 501.

FIG. 3 is a flowchart showing processes which are executed by the blank page processing unit 500. In step S10, the blank page detecting unit 501 discriminates whether or not the page of the image data which was input as mentioned above is the blank page. If it is determined that the page is the blank page as a result of the discrimination, the processing routine advances to step S12 through step S11. The blank page separation/information forming unit 502 obtains information such as a page number and the like of the target page. The blank page image processing unit 503 executes the image process only for the blank page. As an image process here, if some contents are included on the page which was decided as a blank page, a process for enabling the user to easily and visually recognize the information is executed. Although a processing method in this instance is not limited, for example, such a contrast emphasis that distribution of pixel values in the page is obtained and concentration of the pixel values whose distribution is relatively large in the colors other than white or background color is purposely increased is an example of the processing method which provides a large effect. If an edge emphasizing process is executed in a space filter, a thin diagram or the like formed with thin characters or thin lines is emphasized and can be converted so that the image can be easily recognized when it is output.

After that, in step S13, the image data of the blank page which has been image processed is stored into a memory (memory for a file 2) to store the image data. With respect to the page which is not decided as a blank page in step S10, the processing routine advances to step S14 through step S11 and the blank page separation/information forming unit 502 stores the image data into a memory (memory for a file 1) to store the image data of the normal page in the storing unit 107. After that, in step S15, the blank page separation/information forming unit 502 records information showing that the page which is being processed is the blank page or the normal page into a predetermined area in the storing unit 107. As will be described hereinafter, the file 1 is a file consisting of the normal pages not decided as blank pages. The file 2 is a file consisting of the pages decided as blank pages. As mentioned above, the image data in which the blank page has been read is separated from the data which was obtained by reading the original and changed to the image data.

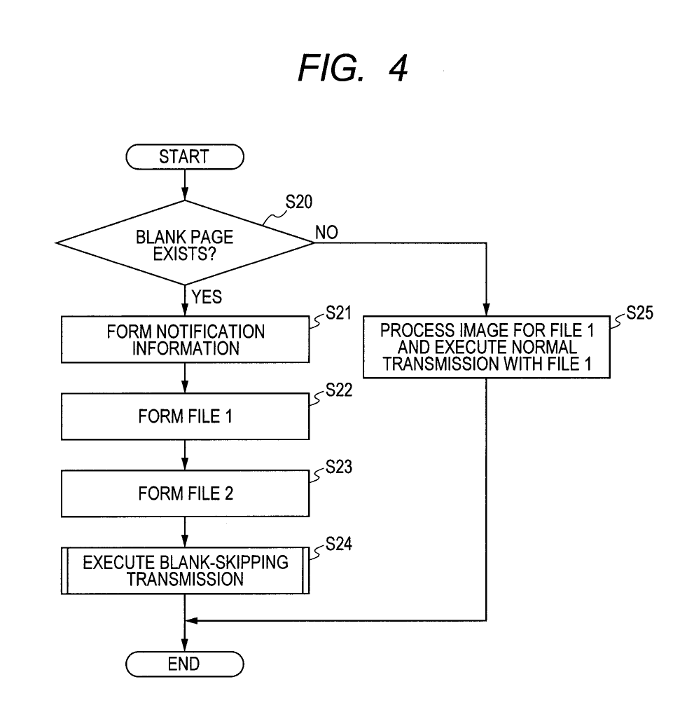

FIG. 4 illustrates a flowchart for processes which are executed to all pages of the image data by the CPU 103 after the processes of FIG. 3 were finished. For simplicity of description here, a case where the blank-skipping function that is peculiar to the embodiment is validated and an image file in which the image data obtained by the scanner 200 was modified is attached to E-mail and the obtained E-mail is transmitted will be mentioned as an example.

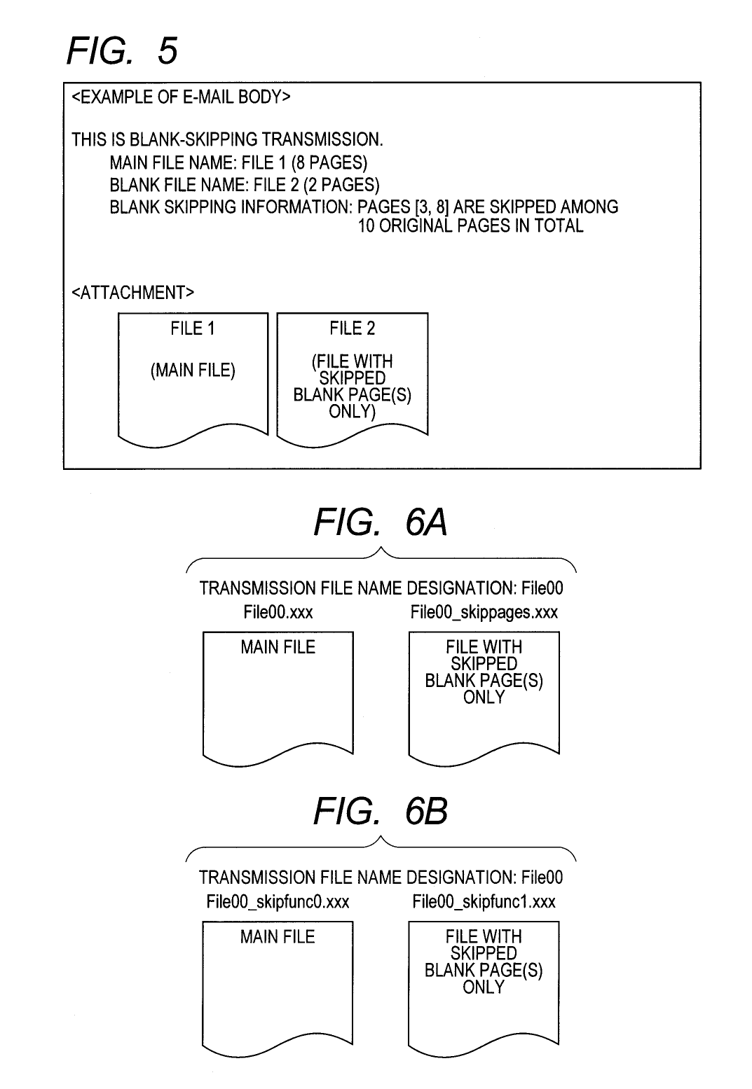

First, in step S20, whether or not the page which was decided as a blank page exists in the original is discriminated with reference to the blank page information recorded in step S15. If no blank page exists here, step S25 follows and the normal transmitting process is executed with the file 1. If it is determined in step S20 that the blank page exists, step S21 follows. In step S21, the blank page information recorded in step S15 in FIG. 3 is obtained and notification information regarding the executed blank-skipping process is formed. As for the notification information, items or the like may be changed in accordance with a transmission protocol, a transmission destination, or the like. In the case of the E-mail transmission like an embodiment, since the notification information can be disclosed as text information in the E-mail body, for example, it is sufficient to form information as illustrated in FIG. 5.

In the example of FIG. 5, the following information is disclosed in the E-mail body, indicating: that the transmission is made using the blank-skipping function;
that the file 1, consisting of the pages which are not blank, is attached;
that the file 2, consisting of the pages decided as blank pages, is attached;
the number of pages included in each of the above two files; and
number(s) of the page(s), in the original, decided as a blank page.

Naturally, further many other information including items which are also disclosed at the time of the normal transmission may be included.

Subsequently, in step S22, the file 1, consisting of the normal pages not decided as blank pages, is formed. Processes similar to those in the method of forming the file 1 at the time of the normal transmission are executed here. Specifically speaking, a correcting process suitable for an electronic image file transmission, a color space conversion which conforms with a general-purpose image file format, and the like are executed in the input image processing unit 111. In step S23, the file 2, consisting of the pages decided as blank pages, is formed. In this instance, the image data in which the image process has been executed to the data in which the pages decided as blank pages were read in step S12 in FIG. 3 is input. A process for minimizing its data size is executed. This is because since it is a file consisting of pages which are presumed to be inherently deleted, it is desirable to suppress a capacity within a range where the image can be confirmed. As a unit for the data size reduction which is executed at the time of the file creation in step S23, there are a unit to reduce the number of pixels by a resolution conversion, a unit to reduce the number of gradations, and the like. Any one of those units may be used. In step S24, a transmitting process is executed. In the case of transmitting the E-mail like an embodiment, the notification information formed in step S21 is disclosed in the E-mail body, the file 1, consisting of the normal pages, and the file 2, consisting of the blank pages, are attached to the E-mail, and the obtained E-mail is transmitted to a designated E-mail address.

Subsequently, a case of applying to a transmitting method of data other than E-mail will be described. As typical cases, a case where the file is transmitted to a server or the like on the network by a communication protocol such as FTP protocol, SMB protocol, or the like and a case where a print output is automatically performed upon reception of a facsimile, an Internet facsimile, or the like as a prerequisite will be mentioned.

FIGS. 6A and 6B illustrate a concept of the files in the case of transmitting an electronic file to the server or the like on the network. In the case of using the function of the embodiment, if the blank pages exist in the original, two files are transmitted: one consisting of the normal pages (corresponding to the file 1 in the above example) and the other consisting of the blank pages (corresponding to the file 2 in the above example). At this time, the reception side has to be able to easily discriminate a correlation between those two files from only file names. Therefore, the names of the two files are automatically formed by a rule illustrated in FIG. 6A on the basis of transmission file names which have been designated by using the operating unit 400 at the start of the transmission or file names which are formed as defaults when there is no designation. That is, the name of the file formed with the normal pages only is assumed to be a name similar to that at the time of the normal transmission. As a name of the file formed with the blank pages only, a predetermined character string is added to the name of the file formed with the normal pages only. Thus, a fact that there is a correlation between those two files can be easily recognized. If it is desired that a fact that the result was obtained by using the present function is clearly reflected to the file name, it is sufficient to apply a rule illustrated in FIG. 6B. That is, the predetermined character string is also added to the name of the file formed with the normal pages only.

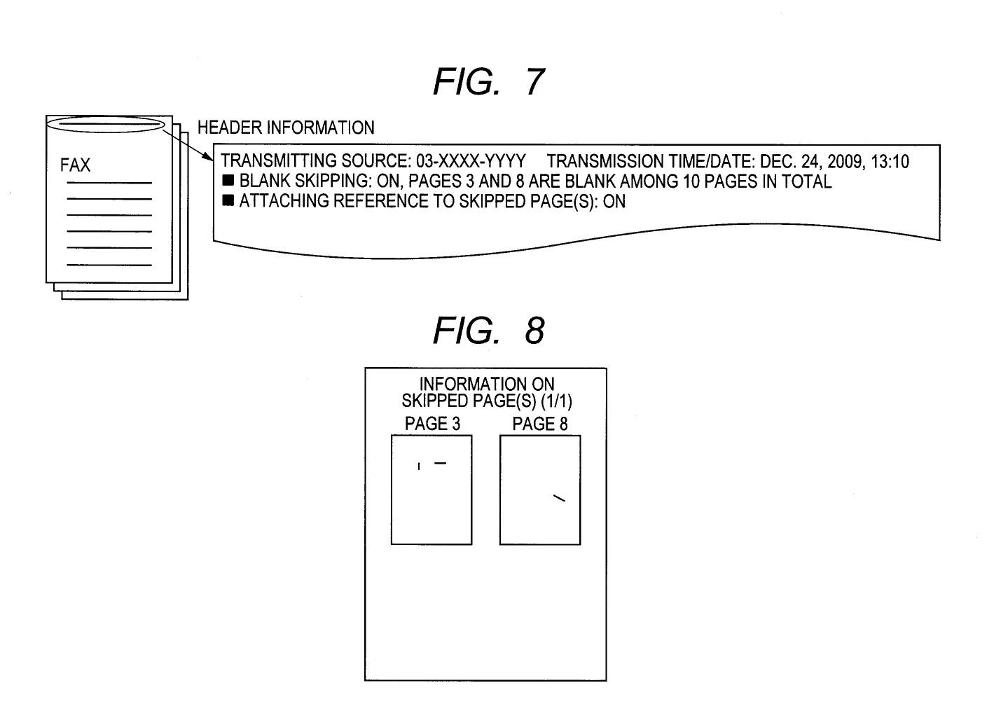

FIG. 7 illustrates an example of header information in the case where the function of the embodiment is used in the facsimile or Internet facsimile. For example, the following information is disclosed in the header, indicating:
that the transmission is made using the blank-skipping function; and
number(s) of the page(s), in the original, decided as a blank page.

FIG. 7 further illustrates that there is a disclosure of “Attaching Reference to Skipped Page(s): ON” and the pages (corresponding to the pages included in the file 2 in the foregoing example) which were determined as blank pages and skipped have been converted into the format for confirmation and simultaneously transmitted. Although the format for confirmation is not particularly limited, for example, a method whereby the pages in the file 2 in the foregoing example are reduced and a plurality of pages are arranged onto one sheet is also effective. FIG. 8 shows such an example and illustrates a state where the skipped third and eighth pages have been reduced and printed onto one sheet. If many blank pages are included, a plurality of such sheets may be output. Such a construction that a reduction ratio of the image of each page is changed and the images of many pages are arranged onto one sheet may be used.

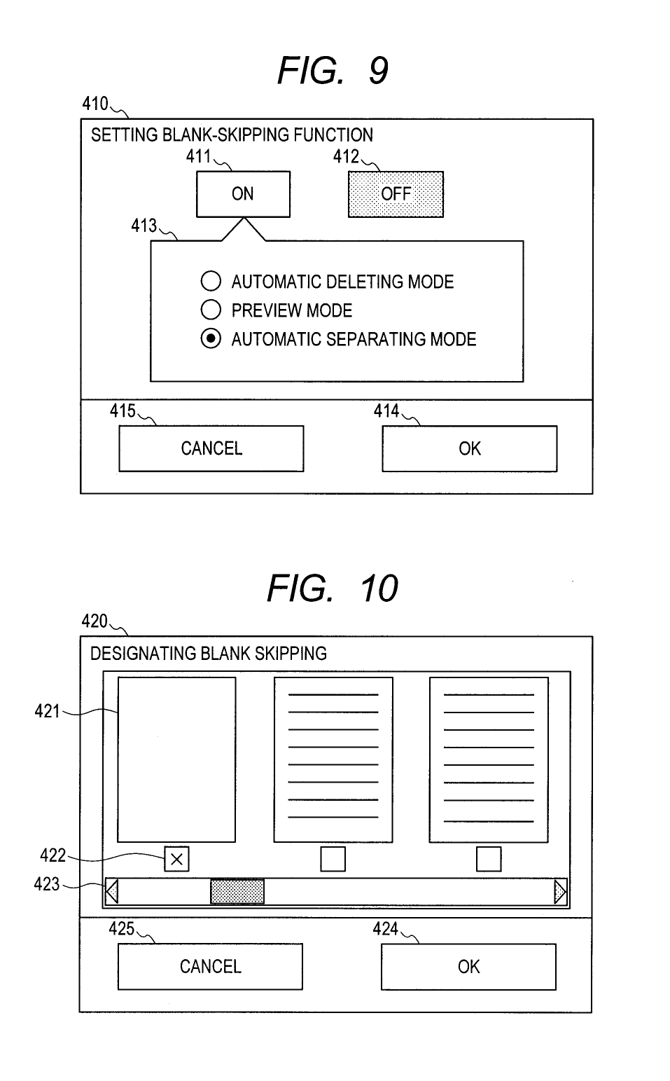

FIG. 9 is an example of an operating display screen on a digital multifunction apparatus for realizing the embodiment. A blank-skipping function setting display screen 410 is a display screen which can be set for all scanning functions including the copy, transmission, and the like. An “ON” button 411 and an “OFF” button 412 showing whether or not the blank-skipping function is validated are exclusive. When the “ON” button 411 is valid, a mode setting area 413 is also valid. In the mode setting area 413, only one of three modes of “Automatic Deleting Mode”, “Preview Mode”, and “Automatic Separating Mode” can be selected. In the case of validating the function in the embodiment, “Automatic Separating Mode” is selected.

“Automatic Deleting Mode” is a mode to automatically delete the pages which were determined as blank pages. Only the pages other than the blank pages are output. Upon transmission in the automatic deleting mode, the data corresponding to the file 1, in which the blank pages have been deleted, is transmitted in step S24 in FIG. 4. Although it is desirable to simultaneously transmit the notification information, it is not always necessary.

“Preview Mode” is a mode in which prior to starting an outputting process to the paper, file, or the like, the scanned pages and the blank page detection results are temporarily displayed on the display screen or the like in the operating unit 400 and the user instructs whether or not the pages are skipped one page by one. Upon transmission in the preview mode, after the processes of FIG. 3 (blank page processing) are finished for all pages, before the processes of FIG. 4, a thumbnail image of each page is displayed onto the display screen in the operating unit 400 together with the blank page detection result of each page. FIG. 10 shows an example of such a display screen.

In the display screen illustrated in FIG. 10, thumbnail images of all pages are displayed in a thumbnail image 421. In the case of the pages which are not decided as blank pages, the CPU 103 forms display image data from the image data read out of the memory for the file 1. In the case of the pages decided as blank pages, the CPU 103 forms display image data from the image data read out of the memory for the file 2. In a check box 422, a check is preliminarily displayed to the box corresponding to the page decided as a blank page. The user checks the check box corresponding to corresponding to the page which the user wants to skip. The user resets the check from the check box corresponding to corresponding to the page which the user does not want to skip. By such an operation, the user selects a skip page. When an OK button 424 is depressed in a state where the page to be skipped has been selected, the skip page is decided. The blank page information (information which is formed in step S15) regarding the page to which an instruction different from a detection result has been made is updated in accordance with the decided information. After that, in step S22, the data is read out of the memory for the file 1 and the memory for the file 2 as necessary in accordance with the updated blank page information and the file 1, consisting of the normal pages, is formed. In step S23, the data is read out of the memory for the file 1 and the memory for the file 2 as necessary and the file 2, consisting of the skipped pages, is formed. In the preview mode, the file 1, in which the blank pages have been deleted, may be transmitted alone or simultaneously together with the file 2, consisting of the notification information and the blank pages.

### Other Embodiments

The invention is also realized by executing the following processes. That is, software (program) for realizing the functions of the embodiments mentioned above is supplied to a system or an apparatus through a network or various kinds of storing media and a computer (or a CPU, MPU, or the like) of the system or apparatus reads out the program and executes processes based thereon.

While present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-281440, filed Dec. 17, 2010, which is hereby incorporated by reference herein in its entirety.

What is claimed is:

1. An image processing apparatus comprising:
a conversion unit configured to convert an original into image data by scanning the original;
a detection unit configured to detect a blank page in the image data converted by the conversion unit;
a separation unit configured to separate image data of the blank page detected by the detection unit from the converted image data; and
a transmission unit configured to transmit to an external apparatus (a) the converted image data from which the image data of the blank page is separated by the separation unit, (b) the separated image data of the blank page, and (c) notification information formed based on a separation result by the separation unit.

2. The image processing apparatus according to claim 1, further comprising an execution unit configured to execute an image process unique to the separated image data of the blank page.

3. The image processing apparatus according to claim 1, wherein the transmission unit transmits the notification information to the external apparatus by a transmission method which is changed in accordance with a communication protocol between the image processing apparatus and the external apparatus.

4. The image processing apparatus according to claim 1, wherein the transmission unit transmits the notification information to the external apparatus by (a) adding the notification information to an E-mail body for an E-mail transmission, (b) adding a character string formed from the notification information to a transmission file name for an FTP protocol or SMB protocol transmission, and (c) adding a character string formed from the notification information to a header for a facsimile or Internet facsimile transmission.

5. The image processing apparatus according to claim 1, further comprising an operation unit configured to designate whether or not the transmission by the transmission unit is to be validated.

6. The image processing apparatus according to claim 5, further comprising a selection unit configured to select a mode in which the separated image data of the blank page is not transmitted, when the transmission is validated by the designation of the operation unit.

7. An image processing method carried out in an image processing apparatus, comprising:
converting an original into image data by scanning the original;
detecting a blank page in the converted image data;
separating image data of the detected blank page from the converted image data; and
transmitting to an external apparatus (a) the converted image data from which the image data of the blank page is separated in the deleting, (b) the separated image data of the blank page, and (c) notification information formed based on a separation result in the separating.

8. An image processing apparatus comprising:
a conversion unit configured to convert a plurality of originals into image data by reading the plurality of originals;
a detection unit configured to detect a blank page in the image data converted by the converting unit;
a separation unit configured to separate image data of the blank page detected by the detection unit from the converted image data; and
a transmission unit configured to transmit to an external apparatus (a) the converted image data except for the image data of the detected blank page and (b) information regarding the image data separated by the separation unit.

9. The image processing apparatus according to claim 8, wherein the separated image data is reduced in size and wherein the transmission unit further transmits the separated image data as reduced in size.

10. An image processing method carried out in an image processing apparatus, comprising:
converting a plurality of originals into image data by reading the plurality of originals;
detecting a blank page in the converted image data;
separating image data of the detected blank page from the converted image data; and
transmitting to an external apparatus (a) the converted image data except for the image data of the detected blank page and (b) information regarding the separated image data.

11. The image processing method according to claim 10, wherein the separated image data is reduced in size and wherein the transmitting further transmits the separated image data as reduced in size.

12. A non-transitory computer-readable storage medium storing a computer program for causing a computer to execute the image processing method according to claim 7.

13. A non-transitory computer-readable storage medium storing a computer program for causing a computer to execute the image processing method according to claim 10.
